(19) United States
(12) Patent Application Publication
(10) Pub. No.: US 2014/0114727 A1
(43) Pub. Date: Apr. 24, 2014

(54) METHOD AND SYSTEM FOR HIERARCHICAL FORECASTING

(71) Applicant: Hewlett-Packard Development Company, L.P., Houston, TX (US)

(72) Inventors: Jerry Z. Shan, Palo Alto, CA (US); Xin Zhang, San Jose, CA (US); Shailendra K. Jain, Cupertino, CA (US); Cipriano A. Santos, Modesto, CA (US); Kay-Yut Chen, Santa Clara, CA (US); Alfy Louis, Danville, CA (US); Shawn G. Williams, Plano, TX (US); Maria Teresa Gonzalez Diaz, Mountain View, CA (US); Siu Po Lee, San Francisco, CA (US)

(73) Assignee: Hewlett-Packard Development Company, L.P., Houston, TX (US)

(21) Appl. No.: 14/063,918

(22) Filed: Oct. 25, 2013

Related U.S. Application Data
(63) Continuation of application No. PCT/US2011/033941, filed on Apr. 26, 2011.

(51) Int. Cl. G06Q 10/06

(52) U.S. Cl. CPC G06Q 10/06375
USPC 705/7.37

(57) ABSTRACT

There is provided a computer-implemented method of generating a data forecasts for different levels of an entity. The method includes generating an aggregate forecast for an upper level entity comprised of two or more components. The method also includes determining mean values and a coefficient of variation for a probability distribution corresponding to future expected decomposition rates for each of the two or more components. A probability distribution parameter vector is computed based on the mean values and the coefficient of variation. The expected future decomposition rates for each of the two or more components may be computed based on the probability distribution parameter vector and a sample observation corresponding to previously observed decomposition values of each of the two or more components. Component forecasts corresponding to each of the two or more components may be computed based on the aggregate forecast and the expected future decomposition rates.

### CROSS-REFERENCE TO RELATED APPLICATION

This application is a continuation of co-pending PCT Patent Application Serial No. PCT/US2011/033941, filed Apr. 26, 2011, the entire contents of which are hereby incorporated by reference as though fully set forth herein.

### BACKGROUND

Various data forecasting tool exists for enabling a business to make informed business decisions in light of future expected business conditions. For example, revenue forecasting may enable a business to determine an allocation of resources among business units in light of the revenue expected to be generated by each business unit.

Business forecasts are often generated at various aggregation levels. For example, a revenue forecast may be generated for an entire enterprise and for individual units within the enterprise. Generating forecasts separately at each level of aggregation can be problematic because such an approach does not account for the structural relationship between the aggregation levels and, thus, loses the additive property from the upper level to the lower level. Further, the forecast performance at the lower level can be significantly inferior to the upper level, because the method does not have a systematical way to leverage the higher predictability power at the more aggregated upper level.

### BRIEF DESCRIPTION OF THE DRAWINGS

Certain embodiments are described in the following detailed description and in reference to the drawings, in which:

FIG. 1 is a block diagram of a computing device that may be used to generate a data forecast, in accordance with embodiments of the invention;

FIG. 2 is a process flow diagram of a method of generating a data forecast, in accordance with embodiments of the invention; and

FIG. 3 is a block diagram showing a non-transitory, computer-readable medium that stores code configured to generate a data forecast, in accordance with an embodiment of the invention.

### DETAILED DESCRIPTION OF SPECIFIC EMBODIMENTS

In an embodiment of the invention, a method is provided for generating data forecasts for various levels of data aggregation, for example, for different hierarchical levels of a business entity. The data forecast may include a revenue forecast, a product demand forecast, or a sales forecast, among others. Different levels of the entity to which the forecast applies are referred to as aggregation levels. For example, an upper level may relate to a business entity as a whole, while a lower level may apply to the various divisions with the business entity. Each individual division within the upper level entity may be referred to as a component of the upper level entity.

In embodiments, a lower level data forecast may be computed for each component of the upper level entity based, in part, on a data forecast generated for the upper level entity. In this way, the forecasting techniques described herein build a predictive relationship between different forecast levels. The forecast for the upper level entity may be referred to as the aggregate forecast, while each of the lower level forecasts may be referred to as component forecasts. The result of each component forecast may be expressed as a decomposition unit. For example, if the forecast is a revenue forecast, the decomposition unit may be a dollar value corresponding to the predicted revenue forecast for that component. Each component forecast corresponds to a decomposition rate, which is a percentage of the aggregate forecast represented by the component forecast. For example, a decomposition rate of 50 percent would indicate that 50 percent of the aggregate forecast value at the upper level is forecast to be generated by the corresponding component at the lower level. In an embodiment, the component forecasts are derived from the upper level forecast using decomposition rates observed from empirical time series data that are related to past observations and forward-looking judgment calls that are related to future expectations.

In embodiments, a multinomial distribution is used for modeling the component units from the aggregate forecast to a component forecast. Further, a Dirichlet distribution may be used to model the decomposition rates. For the Dirichlet distribution, judgment information may be specified to determine mean values and coefficient of variation values corresponding to the component percentages. An aggregate forecast may be generated, and component forecasts may be derived from the aggregate forecast using the decomposition rates. In embodiments, the forecasting techniques described herein may be applied, for example, to revenue forecasting from enterprise level to business unit level, and from enterprise level to different currencies or regions. Furthermore, it will be appreciated that the techniques described herein may be applied to forecasting models that include more than two hierarchical levels.

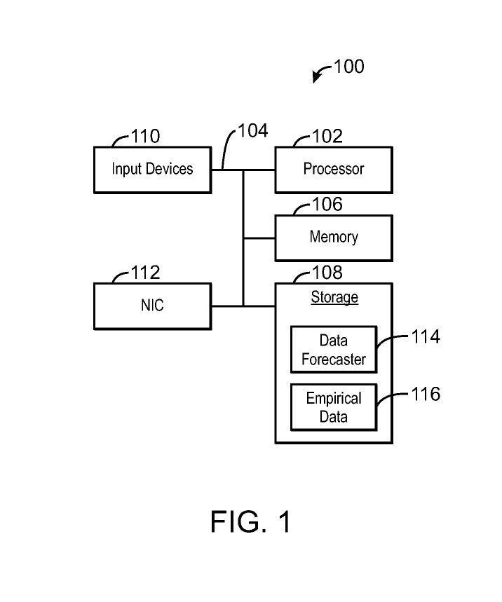

FIG. 1 is a block diagram of a computing device that may be used to generate a data forecast, in accordance with embodiments of the invention. The system is generally referred to by the reference number 100. Those of ordinary skill in the art will appreciate that the functional blocks and devices shown in FIG. 1 may comprise hardware elements including circuitry, software elements including computer code stored on a non-transitory, machine-readable medium, or a combination of both hardware and software elements. Further, the configuration is not limited to that shown in FIG. 1, as any number of functional blocks and devices may be used in embodiments of the invention. Those of ordinary skill in the art would readily be able to define specific functional blocks based on design considerations for a particular electronic device.

As illustrated in FIG. 1, the computing device 100 may include a processor 102 connected through a bus 104 to one or more types of non-transitory, computer readable media, such as a memory 106. The memory 106 may be used during the execution of various programs, including programs used in embodiments of the invention. The memory 106 may include read-only memory (ROM), random access memory (RAM), and the like. The computing device 100 can also include other non-transitory, computer readable media, such as a storage system 108 for the long-term storage of operating programs and data. The storage system 108 may hold the operating programs and data used in embodiments of the invention. The storage system 108 may include, for example, hard disks, optical drives such as CDs, DVDs, and Blu-ray disks, flash memory, and the like.

The computing device 100 can also include one or more input devices 110, such as a mouse, touch screen, and keyboard, among others. In an embodiment, the device 100 includes a network interface controller (NIC) 112, for connecting the device 100 to a network through a local area network (LAN), a wide-area network (WAN), or another network configuration. In an embodiment, the computing device 100 is a general-purpose computing device, for example, a desktop computer, laptop computer, business server, and the like.

The computing device 100 can include a data forecaster 114 that can generate a data forecast, for example, a revenue forecast, a margin forecast, a cash-flow forecast, a product sales forecast in terms of orders or shipments, and the like. The data forecaster 114 may generate an aggregate forecast corresponding to an upper level of an organizational hierarchy such as the whole enterprise. The aggregate forecast may be decomposed into multiple component forecasts corresponding to a lower level of organizational hierarchy, for example, separate business units within the enterprise. Each component forecast corresponds with a decomposition rate that describes a ratio or percentage of the aggregate forecast that pertains to the corresponding component forecast. In other words, the component forecast for a particular component may be computed by multiplying the aggregate forecast by the components decomposition rate.

The data forecast may be based, at least in part, on empirical data 116 related to past performance such as sales data, revenue data, and the like. The empirical data may include data for each business level, including data for the entire enterprise and for each component or business unit. Accordingly, the empirical data may be used to assist in determining the most likely decomposition rate for each component of the aggregate forecast. In some embodiments, the decomposition rates for each component of the aggregate forecast may also be based, at least in part, on user input relating to personal judgment calls about a likely distribution of resources in the future. In embodiments, the empirical data 116 and judgment calls may be combined to generate more realistic decomposition rates for each of the component forecasts.

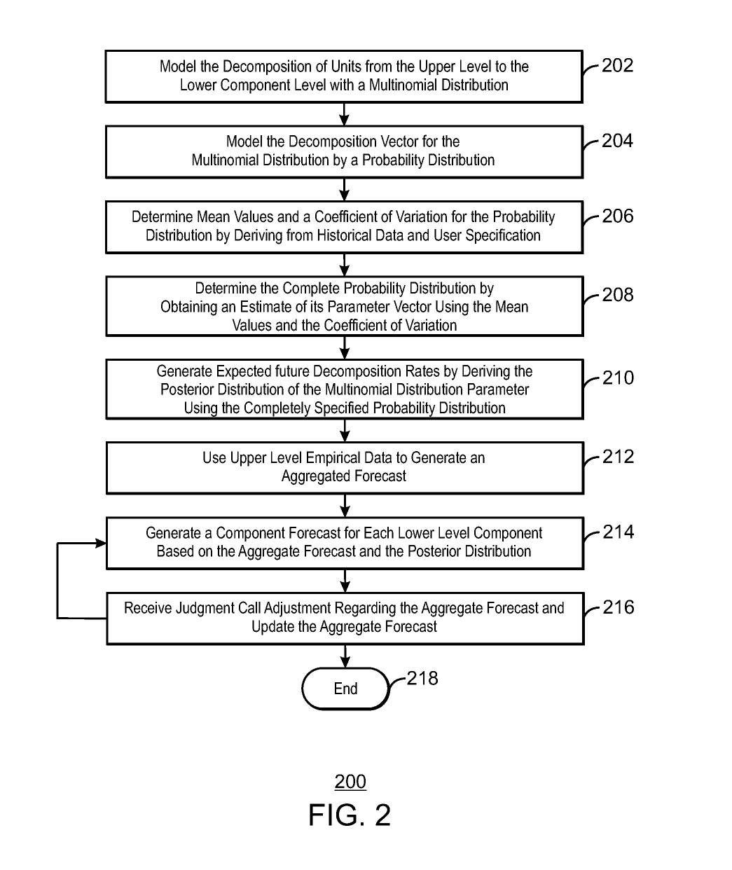

FIG. 2 is a process flow diagram of a method of generating a data forecast, in accordance with embodiments of the invention. The method may be referred to by the reference number 200 and may be executed by the data forecaster 114 discussed with respect to FIG. 1. The method 200 may begin at block 202, wherein the decomposition of units from the upper level to the lower component level may be modeled with a multinomial distribution, \vec{X}|\vec{θ}˜Mul(\vec{θ}), as defined by the statistical model shown in Eqn. 1.

$$P ( \vec{X} = ( {n}_{1} , {n}_{2} , … , {n}_{k} ) ) = \frac{n !}{{n}_{1} ! {n}_{2} ! … {n}_{k} !} {θ}_{1}^{{n}_{1}} {θ}_{2}^{{n}_{2}} … {θ}_{k}^{{n}_{K}} , \\ where n = {\sum }_{i = 1}^{K} {n}_{i} \qquad Eqn . 1$$

In Eqn. 1, the vector, \vec{θ}=(ƒ₁, θ₂, . . . , θ_{K}), is a parameter vector corresponding to the decomposition rates for the K components. The parameter vector, \vec{θ}, may be referred to herein as the “decomposition vector” and may be derived based on historically observed decomposition rates. The decomposition vector, \vec{θ}, in general is not static, as it can change from one period to the next. The vector, \vec{X}=(X₁, X₂, . . . , X_{K}), is the vector of the decomposition units for all the components. Input to the model may be rounded to the nearest whole number in order to apply for the multinomial distribution. In Eqn. 1, \vec{X}=(n₁, n₂, . . . , n_{K}) is a sample observation corresponding to previously observed decomposition units for the K components. For example, the sample observation may be the actual decomposition units, such as revenue amount, realized during a previous reporting period. Given the sample observation, the maximum likelihood estimator of \vec{θ} is

$$\hat{θ} = \frac{\vec{X}}{n} = \frac{\vec{X}}{\vert \vec{X} \vert} ,$$

where |\vec{X}| denotes the L₁ norm of \vec{X}. As described further below, the maximum likelihood estimator may be used to help determine the projected values for the future decomposition rates.

At block 204, the decomposition vector for the multinomial distribution shown in Eqn. 1 can be modeled by a probability distribution. In some embodiments, the probability distribution is a Dirichlet distribution, \vec{θ}˜Dir(\vec{α}), which may be completely determined by the probability distribution parameter vector, \vec{α}. The density function of the Dirichlet distribution describes the likelihood of a random variable taking a particular value among all the possible values that the random variable can take and is defined according to Eqn. 2.

$$f ( \vec{θ} ) = f ( \vec{θ} ; \vec{α} ) = \frac{1}{B ( α )} {\prod }_{i = 1}^{K} {θ}_{i}^{{α}_{i} - 1} , \\ where \\ B ( α ) = \frac{{\prod }_{i = 1}^{K} Γ ( {α}_{i} )}{Γ ( {\sum }_{i = 1}^{K} {α}_{i} )} \qquad Eqn . 2$$

Given the models \vec{X}|\vec{θ}˜Mul(\vec{θ}) and \vec{θ}˜Dir(\vec{α}), it follows that the posterior distribution of the decomposition vector, \vec{θ}, given the demand vector, \vec{X}, is also a Dirichlet distribution. Specifically, \vec{θ}|\vec{X}˜Dir(\vec{α}+\vec{X}). Thus, the expected value for the posterior distribution of the decomposition vector, \vec{θ}, may be determined according to Eqn. 3.

$$E ( \vec{θ} \vert \vec{X} ) = \frac{\vec{α} + \vec{X}}{\vert \vec{α} + \vec{X} \vert} \qquad Eqn . 3$$

Furthermore, the expected value for the posterior distribution of the decomposition vector, \vec{θ}, can be expressed as the weighted average of the expected value of the prior distribution, which is \vec{α}/|α|, and the maximum likelihood estimator from the sample distribution, which is \vec{X}/|\vec{X}|. Thus, the expected values for the posterior distribution of the decomposition vector, \vec{θ}, may be computed according to Eqn. 4.

$$E ( \vec{θ} \vert \vec{X} ) = \frac{\vec{α} + \vec{X}}{\vert \vec{α} + \vec{X} \vert} = \frac{\vert \vec{α} \vert}{\vert \vec{α} + \vec{X} \vert} \frac{\vert \vec{α} \vert}{\vert \vec{α} \vert} + \frac{\vert \overline{X} \vert}{\vert \vec{α} + \vec{X} \vert} \frac{\vec{X}}{\vert \overline{X} \vert} \qquad Eqn . 4$$

The expected value of the posterior distribution provides an updated estimate of the decomposition vector, \vec{θ}, given the observation that we have on the historical decomposition units as well as the prior distribution of the decomposition rates. We note that in Eqn. 4, \vec{X} represents the historical decomposition units, and \vec{α} is the parameter vector for the prior distribution of the decomposition rates.

At block 206, mean values and coefficient of variation values may be determined for the Dirichlet distribution. In an embodiment, a recent window of historical data may be used to derive an estimate for the mean values and coefficient of variation values. In an embodiment, the mean values and coefficient of variation values may be specified by a user. The mean values and coefficient of variation values may be used to compute an estimate for the probability distribution parameter vector, \vec{α}.

In an embodiment, the user may be prompted to provide expected or planned values of the decomposition vector, \vec{θ}. The planned values of the decomposition vector are denoted by the vector, \vec{A}, and may be used as the mean values of the decomposition vector, \vec{θ}. The planned values, \vec{A}, of the decomposition vector, \vec{θ}, may be specified, for example, based on business judgment regarding future planning or desires for the components of the business entity. The user may also be prompted to provide a coefficient of variation value corresponding to the planned values, \vec{A}, of the decomposition vector, \vec{θ}. The coefficient of variation value may be denoted by the parameter, λ, and may represent, for example, a degree of confidence that the user's planned values, \vec{A}, are actually achievable.

At block 208, the complete distribution for the probability distribution may be obtained by computing an estimate of the probability distribution parameter vector, \vec{α}, using the mean values and coefficient of variation values estimated or specified at block 206.

Given the Dirichlet distribution on the decomposition vector, \vec{θ}, it follows that E(\vec{θ})=\vec{α}/|\vec{α}|. Thus, the expected values of the decomposition vector, E(\vec{θ}), may be expressed by the linear equation system of Eqn. 5.

$$E ( \vec{θ} ) = \frac{1}{\vert \vec{α} \vert} \vec{α} = \vec{A} \qquad Eqn . 5$$

Additionally, the variance for each individual decomposition rate may be expressed by Eqn. 6.

$$Var ( {θ}_{i} ) = \frac{E ( {θ}_{i} ) ( 1 - E ( {θ}_{i} ) )}{\vert \vec{α} \vert} = \frac{{A}_{i} ( 1 - {A}_{i} )}{\vert \vec{α} \vert} = {σ}_{i}^{2} \qquad Eqn . 6$$

Solving Eqn. 6 for the probability distribution parameters yields Eqn. 7

$$\vert \vec{α} \vert = \frac{{A}_{i} ( 1 - {A}_{i} )}{{σ}_{i}^{2}} \qquad Eqn . 7$$

Incorporating the coefficient of variation value, λ, into the solution for the probability distribution parameter vector of Eqn. 7 yields Eqn. 8.

$$\vert \vec{α} \vert = mean \{ \frac{{A}_{i} ( 1 - {A}_{i} )}{{( λ {A}_{i} )}^{2}} \} = mean \{ \frac{1}{{λ}^{2}} ( \frac{1}{{A}_{i}} - 1 ) \} \qquad Eqn . 8$$

In Eqn. 8, Aᵢ refers to the i-th component of \vec{A}. Thus, an estimate for the probability distribution parameter vector, \vec{α}, may be computed according to Eqn. 9.

$$\vec{α} = mean \{ \frac{1}{{λ}^{2}} ( \frac{1}{{A}_{i}} - 1 ) \text{:} i = 1 , 2 , … , K \} \vec{A} \qquad Eqn . 9$$

In another embodiment, upper and lower bound estimates for |\vec{α}| may be obtained by replacing the mean function of Eqn. 9 with maximum and minimum functions on the component values

$$\{ \frac{1}{{λ}^{2}} ( \frac{1}{{A}_{i}} - 1 ) \text{:} i = 1 , 2 , … , K \} .$$

With the upper bound and lower bound values determined this way, the robustness of the resulting component level forecasts can be analyzed. For example, if the upper bound and lower bound forecasts are not far away from each other (say within 5%), the forecasting procedure could be considered robust. In another embodiment, the mean function of Eqn. 9 can be replaced by the median function on the component values

$$\{ \frac{1}{{λ}^{2}} ( \frac{1}{{A}_{i}} - 1 ) \text{:} i = 1 , 2 , … , K \} .$$

At block 210, the expected future decomposition rates may be determined. Specifically, the posterior distribution of the multinomial distribution parameter vector may be derived using the completely specified Dirichlet distribution computed at block 208. In an embodiment, the posterior mean and variance are computed. The variance measures the variability of all the values that a random variable takes, relative to its mean value. The calculation for the posterior mean is given in Eqn. 4, and the calculation for the variance for each component is given below:

$$var ( {θ}_{i} \vert \vec{X} ) = \frac{E ( {θ}_{i} \vert \vec{X} ) ( 1 - E ( {θ}_{i} \vert \vec{X} ) )}{\vert \vec{α} + \vec{X} \vert} \qquad Eqn . 10$$

where E(θᵢ|\vec{X}) can be obtained from Eqn. 4. The posterior mean, also referred to as the expected value of the posterior distribution, provides an updated estimate of the future decomposition rates, based on the historical decomposition units as well as the prior distribution. Further, the expected value of the posterior distribution can be expressed as the weighted average of the expected value of the prior distribution and the maximum likelihood estimate from the sample observation as shown in Eqn. 4.

At block 212, empirical data corresponding to the upper level may be used to generate an aggregate forecast. The aggregate forecast may be generated using techniques known in the art, for example, the ARIMA (autoregressive integrated moving average) models, or the Holt-Winters algorithms, among others.

At block 214, a component forecast may be generated for each lower level component based on the aggregate forecast and the posterior distribution of the future decomposition rates generated at block 210. Each component forecast may be computed by multiplying the aggregate forecast by the corresponding future decomposition rate. The component forecast may be a point forecast or an interval forecast. Specifically, the posterior distribution of the decomposition rates may be used to derive the mean and standard deviation for each of the decomposition rates. The point forecast for each component can be computed by multiplying the mean rate by the aggregate forecast. The point forecast for each component can be computed by multiplying the sum of the mean rate and certain multiples of the standard deviation by the aggregate forecast. Note that the point forecast and the interval forecast derived this way are conditional forecasts, conditional on the aggregate forecast. The resulting aggregate forecast and component forecasts may be displayed to the user and/or stored to an electronic storage medium such as the storage medium 108 or the memory 106.

At block 216, the user may optionally provide additional input to adjust the aggregate forecast. For example, with an empirically established price elasticity estimated at 2 for a product line, if the user decides to decrease the price by 5%, then we would expect to see an increase in the sales volume by 10%. This 10% increase in sales can be an input that the user provides once the price-cutting is planned. A simple updating method in this case would be to use the original aggregate forecast (without the price-cutting effect accounted) and increase the aggregate forecast by 10% to account for the new pricing. The aggregate forecast can also be updated based on the user input using other known and more advanced forecasting techniques such as Bayesian forecasting techniques. If the aggregate forecast is adjusted at block 216, the adjustment at the upper level aggregate forecast can be automatically reflected down to the lower level component forecast, in which case, the process flow may return to block 214, and new component forecasts may be generated based, in part, on the new aggregate forecast. If the aggregate forecast is not adjusted, the process flow may advance to block 218 and the process flow terminates.

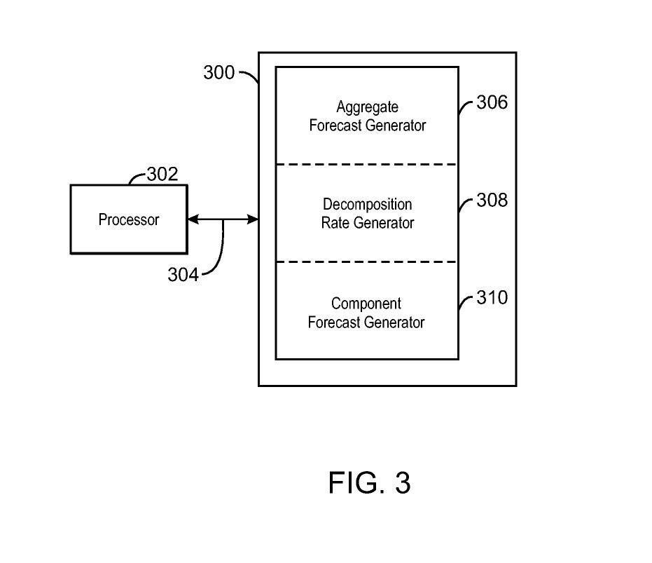

FIG. 3 is a block diagram showing a non-transitory, computer-readable medium that stores code configured to generate a data forecast, in accordance with an embodiment of the invention. The non-transitory, computer-readable medium is referred to by the reference number 300. The non-transitory, machine-readable medium 300 can comprise RAM, a RAM drive, a hard disk drive, an array of hard disk drives, an optical drive, an array of optical drives, a non-volatile memory, a universal serial bus (USB) drive, a digital versatile disk (DVD), a compact disk (CD), and the like. The non-transitory, computer-readable medium 300 may be accessed by a processor 302 over a communication path 304.

As shown in FIG. 3, the various components discussed herein can be stored on the non-transitory, computer-readable medium 300. A first region 306 on the non-transitory, computer-readable medium 300 can include an aggregate forecast generator configured to generate an aggregate forecast for an upper level entity comprised of two or more components, as discussed in relation to block 214 of FIG. 2.

A region 308 can include a decomposition rate generator configured to determine the composition rates applicable to each component of the upper level entity. The decomposition rate generator 308 can be configured to determine mean values and a coefficient of variation for a probability distribution corresponding to future expected decomposition rates for each of the two or more components, as discussed in reference to block 206 of FIG. 2. The decomposition rate generator 308 can also be configured to generate a probability distribution parameter vector based on the mean values and the coefficient of variation, as discussed in reference to block 206 of FIG. 2. The decomposition rate generator 308 can also be configured to generate the expected future decomposition rates for each of the two or more components based on the probability distribution parameter vector and a sample observation corresponding to previously observed decomposition values of each of the two or more components, as discussed in reference to block 212 of FIG. 2.

A region 310 can include a component forecast generator configured to generate component forecasts corresponding to each of the two or more components based on the aggregate forecast and the expected future decomposition rates, as discussed in reference to block 216 of FIG. 2. Although shown as contiguous blocks, the software components can be stored in any order or configuration. For example, if the non-transitory, computer-readable medium 300 is a hard drive, the software components can be stored in non-contiguous, or even overlapping, sectors.

What is claimed is:

1. A method, comprising:
generating a first data structure comprising an aggregate forecast for an upper level entity comprising two or more components;
determining mean values and a coefficient of variation for a probability distribution corresponding to future expected decomposition rates for each of the two or more components;
generating a probability distribution parameter vector based on the mean values and the coefficient of variation;
generating a second data structure comprising the expected future decomposition rates based on the probability distribution parameter vector and a sample observation corresponding to previously observed decomposition values of each of the two or more components; and
generating component forecasts corresponding to each of the two or more components by accessing the first data structure comprising the aggregate forecast and the second data structure comprising the expected future decomposition rates.

2. The method of claim 1, wherein the previously observed decomposition values are modeled by a multinomial distribution.

3. The method of claim 2, wherein a parameter vector of the multinomial distribution is modeled by a Dirichlet distribution which is determined based on the probability distribution parameter vector.

4. The method of claim 1, wherein determining mean values for a probability distribution comprises receiving user input corresponding to a planned future decomposition rate for each of the two or more components.

5. The method of claim 1, wherein the expected future decomposition rates are computed as a weighted average of a maximum likelihood estimator of the sample observation and an expected value of the probability distribution.

6. A computer system, comprising:
a processor that is configured to execute machine-readable instructions; and
a memory device that stores instruction modules that are executable by the processor, the instruction modules comprising code configured to:
generate an aggregate forecast for an upper level entity comprised of two or more components;
determine mean values and a coefficient of variation for a probability distribution corresponding to future expected decomposition rates for each of the two or more components;
generate a probability distribution parameter vector based on the mean values and the coefficient of variation;
generate the expected future decomposition rates for each of the two or more components based on the probability distribution parameter vector and a sample observation corresponding to previously observed decomposition values of each of the two or more components; and
generate component forecasts corresponding to each of the two or more components based on the aggregate forecast and the expected future decomposition rates.

7. The computer system of claim 6, comprising code configured to model the previously observed decomposition values by a multinomial distribution.

8. The computer system of claim 7, comprising code configured to model a parameter vector of the multinomial distribution by a Dirichlet distribution which is determined based on the probability distribution parameter vector.

9. The computer system of claim 6, comprising code configured to determine mean values for the probability distribution by receiving user input corresponding to a planned future decomposition rate for each of the two or more components.

10. The computer system of claim 6, comprising code configured to compute the expected future decomposition rates as a weighted average of a maximum likelihood estimator of the sample observation and an expected value of the probability distribution.

11. A non-transitory, computer readable medium, comprising instruction modules configured to direct a processor to:
generate an aggregate forecast for an upper level entity comprised of two or more components;
determine mean values and a coefficient of variation for a probability distribution corresponding to future expected decomposition rates for each of the two or more components;
generate a probability distribution parameter vector based on the mean values and the coefficient of variation;
generate the expected future decomposition rates for each of the two or more components based on the probability distribution parameter vector and a sample observation corresponding to previously observed decomposition values of each of the two or more components; and
generate component forecasts corresponding to each of the two or more components based on the aggregate forecast and the expected future decomposition rates.

12. The non-transitory, computer readable medium of claim 11, comprising instruction modules configured to direct a processor to model the previously observed decomposition values by a multinomial distribution.

13. The non-transitory, computer readable medium of claim 12, comprising instruction modules configured to direct a processor to model a parameter vector of the multinomial distribution by a Dirichlet distribution which is determined based on the probability distribution parameter vector.

14. The non-transitory, computer readable medium of claim 11, comprising instruction modules configured to direct a processor to determine mean values for the probability distribution by receiving user input corresponding to a planned future decomposition rate for each of the two or more components.

15. The non-transitory, computer readable medium of claim 11, comprising instruction modules configured to direct a processor to compute the expected future decomposition rates as a weighted average of a maximum likelihood estimator of the sample observation and an expected value of the probability distribution.
